(19) United States
(12) Patent Application Publication
(10) Pub. No.: US 2014/0289874 A1
(43) Pub. Date: Sep. 25, 2014

(54) INTEGRATED CIRCUIT (IC) CHIP AND METHOD OF VERIFYING DATA THEREOF

(71) Applicants: Joon-Ho Lee, Yongin-si (KR); Young-Sun Yoo, Seongnam-si (KR)

(72) Inventors: Joon-Ho Lee, Yongin-si (KR); Young-Sun Yoo, Seongnam-si (KR)

(73) Assignee: SAMSUNG SDS CO., LTD., Seoul (KR)

(21) Appl. No.: 14/355,284

(22) PCT Filed: Aug. 27, 2012
(86) PCT No.: PCT/KR2012/006828

§ 371 Date: May 19, 2014

(30) Foreign Application Priority Data
Oct. 31, 2011 (KR) 10-2011-0111802

(51) Int. Cl. G06F 21/64

(52) U.S. Cl. CPC G06F 21/64
USPC 726/32

(57) ABSTRACT

Provided are an IC chip and a method of verifying data thereof. The present invention verifies integrity of data by comparing an integrity verifying value generated from data using an integrity verifying value generating algorithm before a write operation for storing data in a storing unit is performed and an integrity verifying value generated from data stored in the storing unit using the integrity verifying value generating algorithm after the write operation is completed. According to the present invention, the present invention can confirm whether data stored in the IC chip is normally stored when manufacturing/issuing the IC chip and whether data stored in the IC chip is normally stored during the IC chip is used.

### CROSS-REFERENCE TO RELATED APPLICATION

This application is the National Stage of International Application No. PCT/KR2012/006828, filed Aug. 27, 2012, and this application claims the benefit under of a Korean patent application filed in the Korean Intellectual Property Office on Oct. 31, 2011 and assigned Serial No. 10-2011-0111802, the entire disclosure of which is hereby incorporated by reference.

### BACKGROUND

1. Field of the Invention

Exemplary embodiment relates to an integrated circuit (IC) chip and a method of verifying data thereof, and more particularly, to an IC chip for verifying integrity of data to confirm whether data is normally recorded or whether stored data is changed, and a method of verifying data thereof.

2. Discussion of Related Art

An integrated circuit (IC) chip is a device capable of storing and processing a variety of digital information. The IC chip has been used in various fields such as a smart card, a transportation card, a credit card, a debit card, a hardware security module, a copy prevention module, etc. Accordingly, concerns and issues with respect to securities of data stored in the IC chip are being increased.

When integrity of data stored in the IC chip is damaged due to an attack from the outside or its own errors, the IC chip cannot perform its original functions. Further, when the integrity of the data stored in the IC chip is damaged due to malicious attacks from the outside, there is a concern that the IC chip may be abused. Accordingly, development of a method of verifying the integrity of the data stored in the IC chip is needed.

### SUMMARY OF THE INVENTION

One or more exemplary embodiments provide an IC chip and a method of verifying data thereof capable of verifying integrity of data to confirm whether data is normally stored or whether the data is changed.

One or more exemplary embodiments also a computer readable record medium storing a program for executing a method of verifying data of an IC chip for verifying integrity of data to confirm whether data is normally stored or whether the data is changed in a computer.

According to an aspect of an exemplary embodiment, there is provided an IC chip. The IC chip includes a storing unit configured to maintain stored data regardless of whether power is supplied; a verifying value generating unit configured to generate a first integrity verifying value from data stored in the storing unit using an integrity verifying value generating algorithm after a write operation for storing the data in the storing unit is completed; and a verifying unit configured to verify integrity of the data by comparing a second integrity verifying value generated from the data using the integrity verifying value generating algorithm before the write operation for storing the data in the storing unit is performed and the first integrity verifying value.

According to an aspect of another exemplary embodiment, there is provided a computer readable record medium for recording a program for executing a method of verifying data of an IC chip by a computer, the method including: performing a write operation for storing data in a storing unit maintaining stored data regardless of whether power is supplied; generating a first integrity verifying value from the data stored in the storing unit using an integrity verifying value generating algorithm after the write operation is completed; and verifying integrity of the data by comparing a second integrity verifying value generated from the data and the first integrity verifying value using the integrity verifying value generating algorithm before the write operation is performed.

### BRIEF DESCRIPTION OF THE DRAWINGS

FIG. 1 is a diagram for describing a construction of an integrated circuit (IC) chip according to an exemplary embodiment;

FIG. 2 is a diagram for describing a structure of a storing unit of an IC chip according to an exemplary embodiment;

FIGS. 3 and 4 are diagrams for describing an operation of verifying integrity of data to confirm whether data is normally stored according to an exemplary embodiment;

FIGS. 5 and 6 are diagrams for describing an operation of verifying integrity of data to confirm whether data is changed according to an exemplary embodiment;

FIG. 7 is a flowchart for describing a method of verifying data performed when storing data in an IC chip according to an exemplary embodiment; and

FIG. 8 is a flowchart for describing a method of verifying data stored in an IC chip according to an exemplary embodiment.

### DETAILED DESCRIPTION OF EXEMPLARY EMBODIMENTS

Hereinafter, an integrated circuit (IC) chip and a method of verifying data thereof according to embodiments of the inventive concept will be described below in more detail with reference to the accompanying drawings.

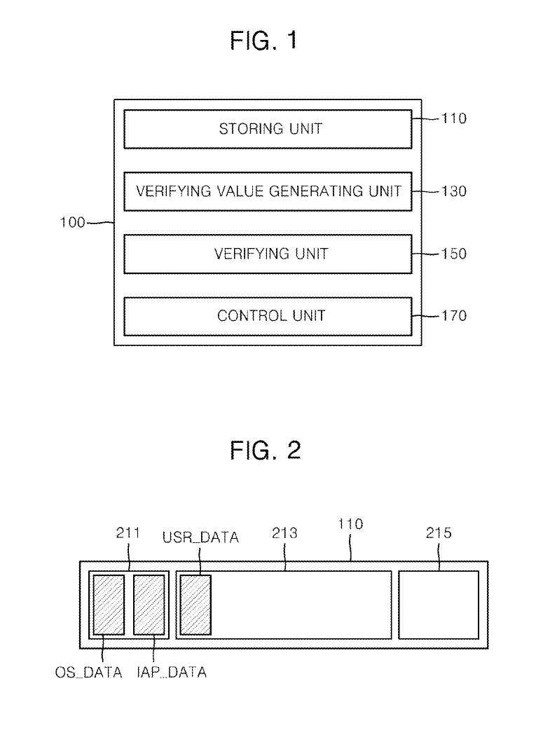

FIG. 1 is a diagram for describing a construction of an integrated circuit (IC) chip according to an exemplary embodiment.

An IC chip 100 according to an exemplary embodiment of the present invention may be connected to an external device (not shown) in a contact or noncontact type. The IC chip 100 may be installed in a smart card, a transportation card, a credit card, a debit card, a hardware security module, a copy prevention module, an electronic identification (ID) card, etc. The IC chip 100 may verify integrity of data to confirm whether data provided from the external device or data generated by its own operation is normally stored in a storing unit or whether data stored in the storing unit is changed. For this, the IC chip 100 may include a storing unit 110, a verifying value generating unit 130, a verifying unit 150, and a control unit 170.

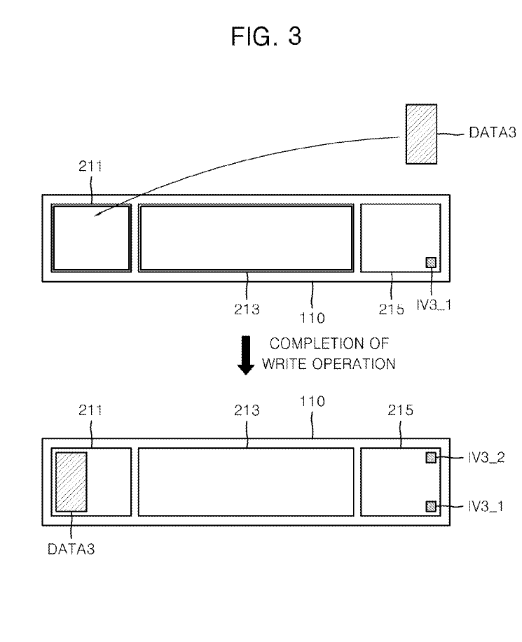

FIG. 2 is a diagram for describing a structure of a storing unit of an IC chip according to an exemplary embodiment.

The storing unit 110 may store a program or various data needed for an operation of the IC chip 100. Referring to FIG. 2, the storing unit 110 may include a first storing unit 211, a second storing unit 213, and a third storing unit 215.

The first storing unit 211 may store software data such as an operating system (OS_DATA) installed in the IC chip 100 and an application (IAPP_DATA) installed when manufacturing/issuing the IC chip 100. The first storing unit 211 may be a storage medium which maintains the stored data regardless of whether power is supplied, and cannot store new data or erase the stored data. A read only memory (ROM), etc. may be used as the first storing unit 211.

The second storing unit 213 may store various data USR_DATA such as data stored when manufacturing/issuing or after issuing the IC chip 100, data used in an operation of the IC chip 100, and software data stored in the first storing unit 211, or an integrity verifying value corresponding to data stored in the second storing unit 213, etc. The data used in the operation of the IC chip 100 may be data needed when using the IC chip 100, and for example, the data may be a certificate, charged money, remaining money, a page counter, a dot counter, a social security number, etc.

The second storing unit 213 may be a storage medium which maintains stored data regardless of whether the power is supplied, and can store new data or erase the stored data. An electrically erasable programmable read only memory (EEPROM), a flash memory, etc. may be used as the second storing unit 213.

The third storing unit 215 may temporarily store data provided from the external device in an operation of the IC chip 100 or generated by its own operation. The third storing unit 215 may be a storage medium which maintains the stored data only when the power is supplied, and can store new data or erase the stored data. A random access memory (RAM), etc. may be used as the third storing unit 215.

The verifying value generating unit 130 may generate an integrity verifying value from data temporarily stored the third storing unit 215 using an integrity verifying value generating algorithm before a write operation for storing data in the first storing unit 211 or the second storing unit 213 is performed. Here, the integrity verifying value generating algorithm may be a cipher block chaining (CBC) message authentication code (MAC) algorithm, a cyclic redundancy check (CRC) algorithm, a one-way hash algorithm, etc. In this case, when the CBC MAC algorithm is used as the integrity verifying value generating algorithm, a symmetric key may be needed. The symmetric key may be previously stored in the storing unit 110 when manufacturing/issuing or after issuing the IC chip 100, or provided from the external device. Further, the verifying value generating unit 130 may store an integrity verifying value generated from data in the second storing unit 213. In this case, the verifying value generating unit 130 may store the integrity verifying value in a protective memory area.

Moreover, the verifying value generating unit 130 may generate the integrity verifying value from data stored in the first storing unit 211 or the second storing unit 213 using the integrity verifying value generating algorithm after the write operation is completed. Here, it may be confirmed whether the write operation is completed through a hardware register for write.

The verifying value generating unit 130 may generate the integrity verifying value from data stored in the first storing unit 211 or the second storing unit 213 using the integrity verifying value generating algorithm.

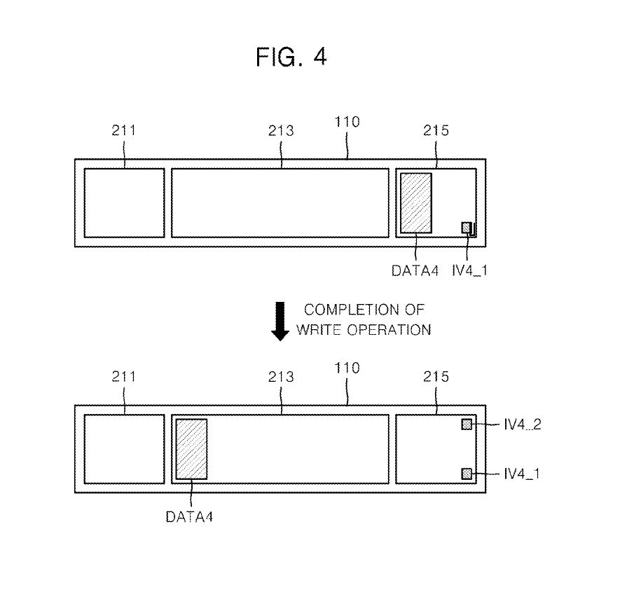

FIGS. 3 and 4 are diagrams for describing an operation of verifying integrity of data to confirm whether data is normally stored according to an exemplary embodiment.

Referring to FIG. 3, the verifying unit 150 may verify integrity of data DATA3 by comparing an integrity verifying value IV3_1 generated from the data DATA3 before an write operation for storing the data DATA3 in the first storing unit 211 is performed when manufacturing/issuing the IC chip 100 and an integrity verifying value IV3_2 generated from the data DATA3 stored in the first storing unit 211 after the write operation is completed. Here, the integrity verifying value IV3_1 generated from the data DATA3 before the write operation is performed may be provided from the external device and be temporarily stored in the third storing unit 215. At this time, the verifying unit 150 may use a CBC MAC algorithm as the integrity verifying value generating algorithm for generating the integrity verifying values IV3_1 and IV3_2 from the data DATA3. The CBC MAC algorithm, etc. may be used for verifying in high intensity whether the data DATA3 is normally stored.

Referring to FIG. 4, the verifying unit 150 may verify integrity of data DATA4 by comparing an integrity verifying value IV4_1 generated from the data DATA4 temporarily stored in the third storing unit 215 before the write operation for storing the data DATA4 in the second storing unit 213 is performed and an integrity verifying value IV4_2 generated from the data DATA4 stored in the second storing unit 213 after the write operation is completed.

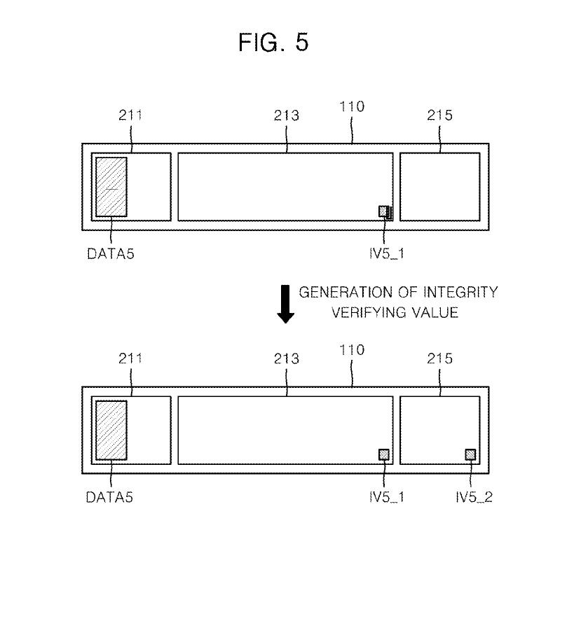

FIGS. 5 and 6 are diagrams for describing an operation of verifying integrity of data to confirm whether data is changed according to an exemplary embodiment.

Referring to FIG. 5, the verifying unit 150 may verify integrity of data DATA5 by comparing an integrity verifying value IV5_2 generated from data DATA5 stored in the first storing unit 211 and an integrity verifying value IV5_1 stored in the second storing unit 213 and corresponding to the data DATA5. Referring to FIG. 6, the verifying unit 150 may verify integrity of data DATA6 by comparing an integrity verifying value IV6_2 generated from the data DATA6 stored in the second storing unit 213 and an integrity verifying value IV6_1 stored in the second storing unit 213 and corresponding to the data DATA6.

The verifying unit 150 may compare integrity verifying values for verifying integrity of data stored in the first storing unit 211 or the second storing unit 213 when a comparing command is input or periodically. At this time, the verifying unit 150 may use a CRC algorithm or a one-way hash algorithm as an integrity verifying value generating algorithm when generating an integrity verifying value from the data stored in the first storing unit 211 or the second storing unit 213. When verifying the integrity of the stored data periodically to guarantee a response time of the IC chip 100, the verifying unit 150 may use an algorithm having a small amount of computation such as the CRC algorithm or the one-way hash algorithm. In this case, the integrity verifying value corresponding to the data stored in the first storing unit 211 or the second storing unit 213 may be generated using the CRC algorithm or the one-way hash algorithm, and be stored in the second storing unit 213.

The control unit 170 may control overall operations of the IC chip 100. The control unit 170 may control the verifying value generating unit 130 and the verifying unit 150 to perform an integrity verifying operation of the data stored in the first storing unit 211 or the second storing unit 213 when storing data provided from the external device in the first storing unit 211 or the second storing unit 213 in manufacturing/issuing the IC chip 100. At this time, the control unit 170 may perform the integrity verifying operation only when an integrity verifying command is input from the external device. The control unit 170 may provide an integrity verifying result (‘pass’ or ‘fail’) for the external device or store in the storing unit 110.

The control unit 170 may control the verifying value generating unit 130 and the verifying unit 150 while the IC chip 100 is used to perform the integrity verifying operation of the data stored in the first storing unit 211 or the second storing unit 213. At this time, when communicating data with the external device while using the IC chip 100, the control unit 170 may perform the integrity verifying operation when the integrity verifying command is input from the external device or periodically. The control unit 170 may shut down the use of the IC chip 100 when the integrity verifying result is determined to be failed.

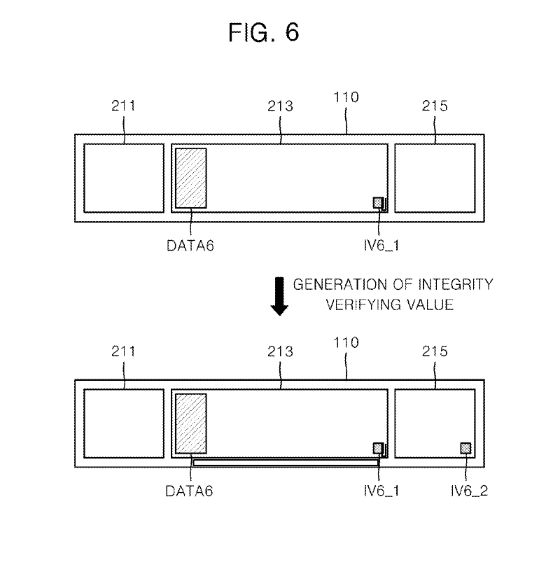

FIG. 7 is a flowchart for describing a method of verifying data performed when storing data in an IC chip according to an exemplary embodiment.

A method of verifying data performed when storing data in the IC chip 100 may include generating an integrity verifying value from data before the IC chip 100 performs a write operation for storing data in a storing unit (S710). Here, the storing unit may maintain the stored data regardless of whether the power is supplied. In this operation, the IC chip 100 may store the generated integrity verifying value in the storing unit.

The method may include performing the write operation for storing the data in the storing unit (S720), and generating an integrity verifying value from the data stored in the storing unit after the write operation is completed (S730). After this, the method may include verifying integrity of the data by comparing the integrity verifying value generated before the write operation is performed and the integrity verifying value generated after the write operation is performed (S740). The IC chip 100 may provide an integrity verifying result for the external device or store the integrity verifying result in the storing unit.

The IC chip 100 may perform the integrity verifying operation described above only when an integrity verifying command is input from the external device.

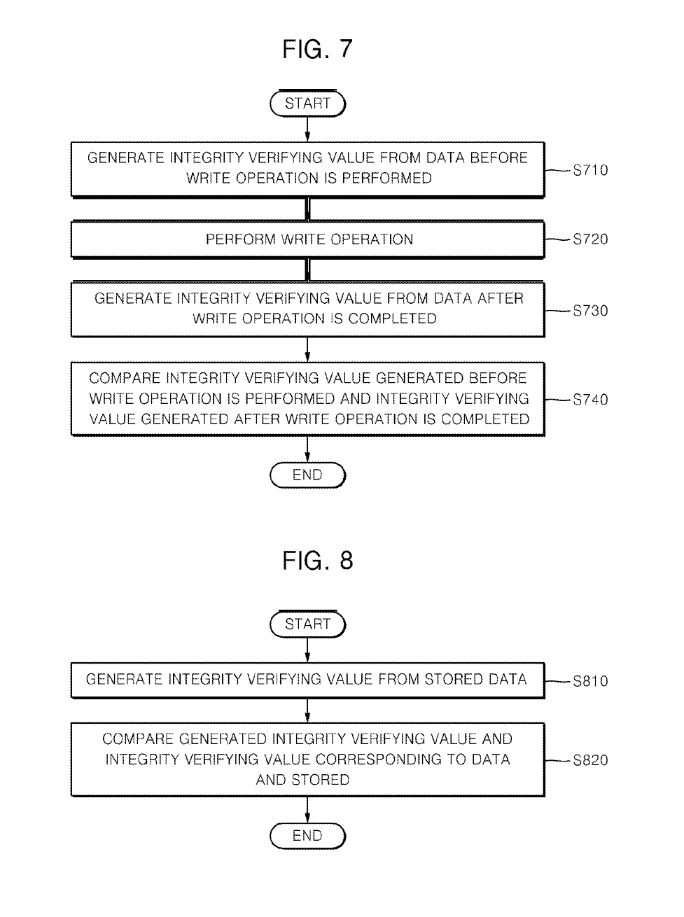

FIG. 8 is a flowchart for describing a method of verifying data stored in an IC chip according to an exemplary embodiment.

A method of verifying data stored in the IC chip 100 may include generating an integrity verifying value from data stored in the storing unit (S810). In this case, the IC chip 100 may generate the integrity verifying value from the data using a CRC algorithm or a one-way hash algorithm.

The method may include verifying integrity of the data by comparing the generated integrity verifying value and an integrity verifying value stored in the storing unit and corresponding to the data (S820). The IC chip 100 may provide a result of verifying the integrity of the data for the external device, or store the result thereof in the storing unit.

When communicating the data with an external device during the IC chip 100 is used, the IC chip 100 may perform the integrity verifying operation described above when an integrity verifying command is input from the external device or periodically.

Meanwhile, an operation of generating an integrity verifying value from data before a write operation for storing data in the IC chip 100 is performed, an operation of generating an integrity verifying value from data stored in the IC chip 100 after the write operation is completed, and an operation of comparing an integrity verifying value generated before the write operation is performed and an integrity verifying value generated after the write operation is completed were described above as being performed by the IC chip 100. However, according to an embodiment without limiting thereto, the IC chip 100 may be provided the integrity verifying value generated from the data from the external device before the write operation is performed. Further, the IC chip 100 may provide the integrity verifying value generated from the data stored in the IC chip 100 for the external device after the write operation is completed. Then, the external device may perform an operation of comparing the integrity verifying value generated before the write operation is performed and the integrity verifying value generated after the write operation is completed.

In addition, an operation of generating an integrity verifying value from the data stored in the IC chip 100, and an operation of comparing an integrity verifying value stored in the IC chip 100 and corresponding to the data and the generated integrity verifying value were described above as being performed by the IC chip 100. However, according to an embodiment without limiting thereto, the IC chip 100 may provide the integrity verifying value generated from the data stored in the storing unit for the external device. Then, the external device may perform an operation of comparing the integrity verifying values. In this case, the external device may store the integrity verifying value corresponding to the data stored in the IC chip 100.

Meanwhile, when performing the integrity verifying operation of the data according to an embodiment of the present invention by connecting the IC chip 100 and the external device, an authentication operation may be performed between the IC chip 100 and the external device. That is, when the authentication is successfully made between the IC chip 100 and the external device, the integrity verifying operation according to an embodiment of the present invention may be performed.

The present invention may be implemented as computer readable codes in a computer readable record medium. The computer readable record medium may include all types of record media in which computer readable data is stored. Examples of the computer readable record medium may include a ROM, a RAM, a CD-ROM, a magnetic tape, a floppy disk, an optical data storage, etc. Further, the record medium may be implemented in the form of a carrier wave (transmission through the Internet). In addition, the computer readable record medium may be distributed to computer systems over a network, in which computer readable codes may be stored and executed in a distributed manner.

In an integrated circuit (IC) chip and a method of verifying data thereof according to the exemplary embodiments, it is possible to confirm whether data for storing in the IC chip is normally stored when manufacturing/issuing the IC chip by comparing integrity verifying values generated from data before and after storing the data. Further, the present invention can confirm whether data for storing in the IC chip is normally stored during the IC chip is used.

Moreover, the present invention can confirm whether data stored in the IC chip is changed by comparing an integrity verifying value generated from data stored in the IC chip and an integrity verifying value corresponding to the data and stored in the IC chip.

While exemplary embodiments have been illustrated and described above, the inventive concept is not limited to the aforementioned specific exemplary embodiments. Those skilled in the art may variously modify the exemplary embodiments without departing from the gist of the inventive concept claimed by the appended claims and the modifications are within the scope of the claims.

What is claimed is:

1. An IC chip, comprising:
a storing unit configured to maintain stored data regardless of whether power is supplied;
a verifying value generating unit configured to generate a first integrity verifying value from data stored in the storing unit using an integrity verifying value generating algorithm after a write operation for storing the data in the storing unit is completed; and
a verifying unit configured to verify integrity of the data by comparing a second integrity verifying value generated from the data using the integrity verifying value generating algorithm before the write operation for storing the data in the storing unit is performed and the first integrity verifying value.

2. The IC chip according to claim 1, wherein the verifying value generating unit generates the second integrity verifying value from the data using the integrity verifying value generating algorithm before the write operation is performed.

3. The IC chip according to claim 1 or 2, wherein the second integrity verifying value is stored in the storing unit, and
the verifying unit generates the first integrity verifying value periodically from the data stored in the storing unit using the integrity verifying value generating algorithm and verifies the integrity of the data by comparing the generated first integrity verifying value and the second integrity verifying value.

4. The IC chip according to claim 3, wherein the integrity verifying value generating algorithm is a cyclic redundancy check (CRC) algorithm or a one-way hash algorithm.

5. The IC chip according to claim 1 or 2, wherein the integrity verifying value generating algorithm is a cipher block chaining message authentication code (CBC MAC) algorithm.

6. The IC chip according to claim 1 or 2, wherein the IC chip is installed in a hardware security module.

7. A computer readable record medium for recording a program for executing a method of verifying data of an IC chip by a computer, the method comprising:
performing a write operation for storing data in a storing unit maintaining stored data regardless of whether power is supplied;
generating a first integrity verifying value from the data stored in the storing unit using an integrity verifying value generating algorithm after the write operation is completed; and
verifying integrity of the data by comparing a second integrity verifying value generated from the data and the first integrity verifying value using the integrity verifying value generating algorithm before the write operation is performed.

8. The computer readable record medium for recording the program for executing the method of verifying the data of the IC chip by the computer according to claim 7, wherein the method further comprises generating the second integrity verifying value from the data using the integrity verifying value generating algorithm before the write operation is performed.

9. The computer readable record medium for recording the program for executing the method of verifying the data of the IC chip by the computer according to claim 7 or 8, wherein the method further comprises storing the second integrity verifying value in the storing unit, and
the verifying of the integrity of the data generates the first integrity verifying value periodically from the data stored in the storing unit using the integrity verifying value generating algorithm, and verifies the integrity of the data by comparing the generated first integrity verifying value and the second integrity verifying value.

10. The computer readable record medium for recording the program for executing the method of verifying the data of the IC chip by the computer according to claim 9, wherein the integrity verifying value generating algorithm is a CRC algorithm or a one-way hash algorithm.

11. The computer readable record medium for recording the program for executing the method of verifying the data of the IC chip by the computer according to claim 7 or 8, wherein the integrity verifying value generating algorithm is a CBC MAC algorithm.
